(19) United States
(12) Patent Application Publication
(10) Pub. No.: US 2002/0097861 A1
(43) Pub. Date: Jul. 25, 2002

(54) Narrow band shadow encoder

(75) Inventors: Franklyn H. Story, Chandler, AZ (US); Samuel L. Thomasson, Gilbert, AZ (US); Justin L. Allen, Mesa, AZ (US); Judy Mae Fong, Chandler, AZ (US); Scott E. Harrow, Scottsdale, AZ (US)

Correspondence Address: Paul F. Wille, 6407 East Clinton Street, Scottsdale, AZ, 85254, US

(73) Assignee: Acoustic Technologies, Inc.

(21) Appl. No.: 09/769,564

(22) Filed: Jan. 25, 2001

(51) Int. Cl. H04M 1/00; H04M 9/00

(52) U.S. Cl. 379/387.02

(57) ABSTRACT

An audio signal is divided into a plurality of bands prior to generating a shadow. The shadow is created by delaying the portion of the audio signal in at least one band by less than fifty milliseconds and combining the shadow signal with the portion of the audio signal. The portions, with any shadows, are combined to produce a reconstructed audio signal. The presence or absence of a shadow signal represents data or the data is represented by two or more shadow signals, in one or more bands. The period of delay of a portion in a band should not equal the period of the center frequency of that band. Preferably, the period of delay of a portion in a band does not equal the period of any frequency within the pass band.

### CROSS-REFERENCE TO RELATED APPLICATION

This application relates to application Ser. No. 09/435,374, filed Nov. 5, 1999, entitled Background Communication Using Shadow of Audio Signal, and assigned to the assignee of this invention, now U.S. Pat. No. ______. The entire contents of this prior application are incorporated by reference herein.

### BACKGROUND OF THE INVENTION

This invention relates to telephone systems and, in particular, to transferring data within the voice band over a telephone line during a conversation. As used herein, a telephone “line” includes cellular telephones.

At present, there are two kinds of echo in a telephone system, an acoustic echo between an earphone or a speaker and a microphone and an electrical echo occurring in the switched network for routing a call between stations. In a handset, acoustic echo is typically not much of a problem. In speaker phones, where several people huddle around a microphone and loudspeaker, acoustic feedback is much more of a problem. Hybrid circuits (two-wire to four-wire transformers) located at terminal exchanges or in remote subscriber stages of a fixed network are the principal sources of electrical echo, also known as line echo.

An echo is perceived as an echo if the delay is greater than approximately fifty milliseconds. Acoustic echoes and line echoes typically far exceed this threshold. Between about twenty milliseconds and about fifty milliseconds, an echo can impart a certain richness to a sound, as is often done to enhance the thin voices of some recording artists.

It has been discovered that imperceptible echoes, that is, echoes having a delay less than about fifty milliseconds, can be used to transmit data in the voice band during a telephone conversation. The need for such capability has long existed. Telephones, and particularly cellular telephones, transmit considerable amounts of data prior to completing a call, i.e. prior to making a connection to the other party. Some data is transmitted after a party hangs up. The problem is that no data is transmitted during a call. The reason is obvious, no one wants a telephone beeping away in the background or the hiss of a multiplexed signal during a call.

There are many occasions when it would be desirable and extremely useful to be able to send data during a call. For example, in conference calls, one party invariably sounds louder than another and there is no way to make an adjustment during a call, except to interrupt the conversation to ask the louder party to speak more softly, which the louder party forgets to do after a few minutes.

There are many other situations that could be improved by being able to send data during a telephone call. For example, the time remaining on a pre-paid call could be sent and displayed at the payer's telephone. Data concerning routing or the quality of the line could also be exchanged.

Filtering a voice signal to eliminate echo is known in the art. Devices known as complementary comb filters have been used to eliminate echoes by having the signal to a speaker filtered through the pass bands of a first comb filter, thereby falling within the stop bands of a second, complementary comb filter coupled to a microphone. If all telephones are configured the same way, some sort of spectrum shift must take place to move undesired signals into the stop bands of a comb filter in order to eliminate both acoustic echoes and line echoes. U.S. Pat. No. 5,386,465 (Addeo et al.) discloses a frequency “scaler” for moving signals into a stop band.

The same type of comb filter can be used in each channel of a telephone if one also uses a frequency shift, see U.S. Pat. No. 4,748,663 (Phillips et al.). Frequency shifting and frequency scaling are undesirable because of their effect on the quality of the voice signal. Providing complementary filters would be simple and effective if telephones could communicate with each other during a call to select which filter to use to assure a complementary relation rather than both telephones using the same pass bands and stop bands.

The above-identified co-pending application describes a system in which an audio signal is delayed less than fifty milliseconds to produce a shadow signal that is combined with the original signal and coupled to the line output of a telephone. The presence or absence of a shadow, or a plurality of shadows, can be used to transmit data imperceptibly over a telephone line. In the particular application of a telephone line, the telephone system includes a filter that blocks frequencies less than 200 Hz. This cut-off frequency limits delay to a maximum of five milliseconds. Other applications for the invention may have different cut-off frequencies, or no cut-off frequency, such that any delay less than fifty milliseconds can be used.

Voice signals have a large, periodic content. Attempting to correlate to a periodic delay has difficulties because of false indications of correlation. It has been found that, in some circumstances, adding one or more shadow signals to the original can cause constructive and destructive interference that corrupts the spectral content of the original signal, particularly if plural shadows are added. Plural shadows can interfere with each other or with the original signal.

In view of the foregoing, it is therefore an object of the invention to provide an apparatus and method for communicating data unobtrusively over a telephone line during a conversation.

Another object of the invention is to communicate data, including control signals, over a telephone line during a conversation.

A further object of the invention is to provide an apparatus and method for communicating data over a telephone line simultaneously with voice signals, i.e. without multiplexing voice and data.

Another object of the invention is to provide an apparatus and method for adding one or more shadow signals to an original signal without corrupting the original signal.

A further object of the invention is to provide an apparatus and method for eliminating false correlations when detecting a shadow.

### SUMMARY OF THE INVENTION

The foregoing objects are achieved in this invention in which an audio signal is divided into a plurality of bands prior to generating a shadow. The shadow is created by delaying the portion of the audio signal in at least one band by less than fifty milliseconds and combining the shadow signal with the portion of the audio signal. The portions, with any shadows, are combined to produce a reconstructed audio signal. The presence or absence of a shadow signal represents data or the data is represented by two or more shadow signals, in one or more bands. The period of delay of a portion in a band should not equal the period of the center frequency of that band. Preferably, the period of delay of a portion in a band does not equal the period of any frequency within the pass band.

### BRIEF DESCRIPTION OF THE DRAWINGS

A more complete understanding of the invention can be obtained by considering the following detailed description in conjunction with the accompanying drawings, in which:

FIG. 1 is a block diagram of the basic elements of the invention;

FIG. 2 is a block diagram of a system for encoding digital data with two delays;

FIG. 3 is a block diagram of a shadow encoder constructed in accordance with the invention;

FIG. 4 is a chart for explaining the operation of a shadow encoder constructed in accordance with the invention;

FIG. 5 is a block diagram of a system for decoding data represented by two delays;

FIG. 6 is a block diagram of a decoding system constructed in accordance with a preferred embodiment of the invention; and

FIG. 7 is a block diagram of a telephone constructed in accordance with a preferred embodiment of the invention.

### DETAILED DESCRIPTION OF THE INVENTION

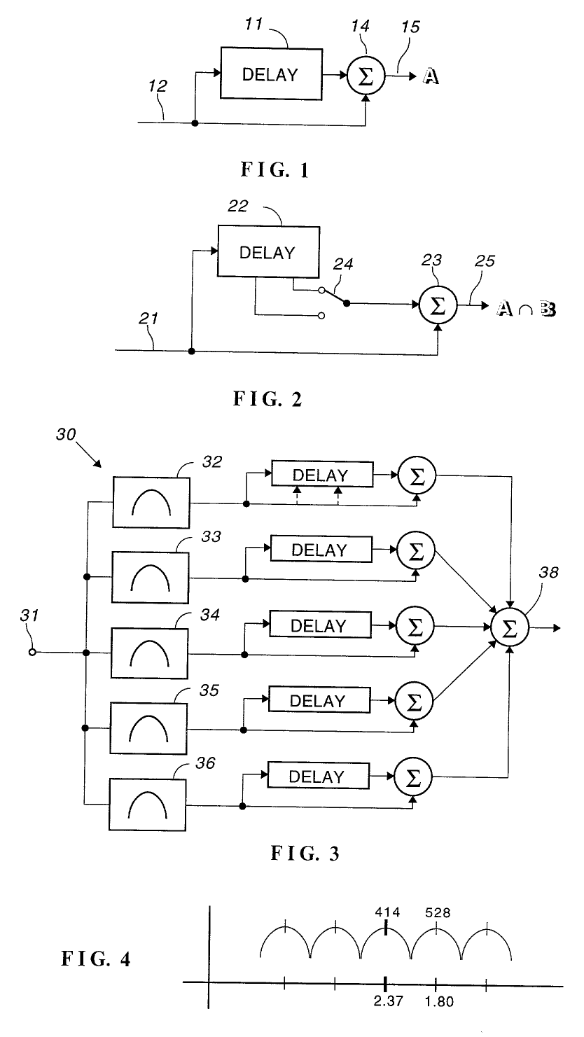

As illustrated in FIG. 1, the invention operates by delaying a signal a small amount, less than fifty milliseconds, to produce an echo, herein called a “shadow” to distinguish it from perceptible echoes, and adding the shadow to the original signal. The signal, and the delay, can be analog or digital.

Delay circuit 11 is preferably a switched capacitor network that stores samples of the signal on input 12. The delay is produced by reading the samples a predetermined time after writing. If delay 11 has one hundred forty-four storage sites, then a three millisecond delay is produced by reading one hundred thirty two sites following the write signal, at a sample frequency of 44.1 kHz.

Summation circuit 14 is preferably active, e.g. an operational amplifier, rather than passive, e.g. a resistive summing network. Output signal 15 can be filtered, digitized, converted back to analog form, etc. in a telephone switching network without losing intelligibility or the shadow. Digital information can be represented by the presence or absence of a shadow to indicate a one or a zero but it is preferred to use two shadows for a more robust implementation.

FIG. 2 is a block diagram of a circuit for modulating an audio signal with data. Input 21 is coupled to delay 22 and to summation circuit 23. Delay 22 includes two taps, e.g. at 2.25 milliseconds and at 3.0 milliseconds. Depending upon which tap is selected, the output signal includes either shadow A or shadow B. The shadows are alternative in this example of the invention but could be simultaneous for other applications.

Tests have shown that a difference of about six percent in the amount of delay produces signals that have essentially zero correlation. Thus, each shadow can be detected even when the shadows are simultaneous and continuous. The tests also indicated that the more random the signal, the less separation necessary for zero correlation. That is, purely random signals could have shadows separated by much less than one millisecond and still be distinguished. Six percent should be understood as a rule of thumb or a guide dealing with audio signals, not as an absolute lower limit.

FIG. 3 is a block diagram of a shadow encoder constructed in accordance with the invention, A signal on input 31 is coupled to band pass filters 32, 33, 34, 35, and 36, each having a different center frequency. The output from each filter is coupled to a shadow encoder as shown in FIG. 1. A single shadow (delay) is shown for the sake of simplicity but more than one shadow can be used per band, subject to the restriction described in connection with FIG. 4. The output of each encoder is coupled to summation network 38. The output of summation network 38 is the output of encoder 30.

Except for velar sounds and unvoiced fricatives, a human voice has a substantial periodic content. It has been found that the operation of the shadow encoder is substantially improved if a signal is divided into bands prior to encoding and if the delay chosen is not the period of a frequency within the bandwidth of the filter with which the delay is used. The first condition substantially increases the number of shadows that can be used. The second condition substantially improves detection of a shadow, even where the voice band is not sub-divided.

FIG. 4 illustrates the second condition. Assume that the center frequencies of two channels are 414 Hz and 528 Hz. A delay of 1.80 ms. is approximately the period of 528 Hz. A delay of 2.37 ms. is approximately the period of 414 Hz. The second condition is that a delay may not equal the period of the center frequency of a band with which the delay is used. Thus, the 414 Hz. band can use any delay except a delay of 2.37 ms. Similarly, the 528 Hz. band may not use a delay of 1.80 ms. By avoiding such delays, false correlations are substantially eliminated. Despite the increased number of shadows, a system constructed in accordance with the invention operates more reliably than a system constructed in accordance with the above-identified application.

FIG. 5 is a block diagram of a circuit for detecting two shadows, whether they be simultaneous or alternative. A signal on input 41 is coupled through bandpass filter 42 to delay 43 and to one input of correlator 44. A second input to correlator 44 is coupled to a tap on delay 43. The signal on input 41 is also coupled through bandpass filter 45 to delay 46 and to one input of correlator 47. A second input to correlator 47 is coupled to a tap on delay 46. The output of correlator 44 is coupled to averaging circuit or low pass filter 48. The output of correlator 47 is coupled to averaging circuit or low pass filter 49.

Correlators or multipliers, particularly in analog form, can be quite complex. A ring modulator is known in the art as an amplitude inverting multiplier circuit. Recent examples of such ring modulators are described in U.S. Pat. Nos. 5,455,543 and 5,455,544. An even simpler circuit, known in the art, is a multiplying phase detector; see Brennan, Paul V., Phase-Locked Loops: Principles and Practice, R. R. Donnelley & Sons Company (1996), pages 8-9. A form of the latter circuit has been used in one embodiment of the invention.

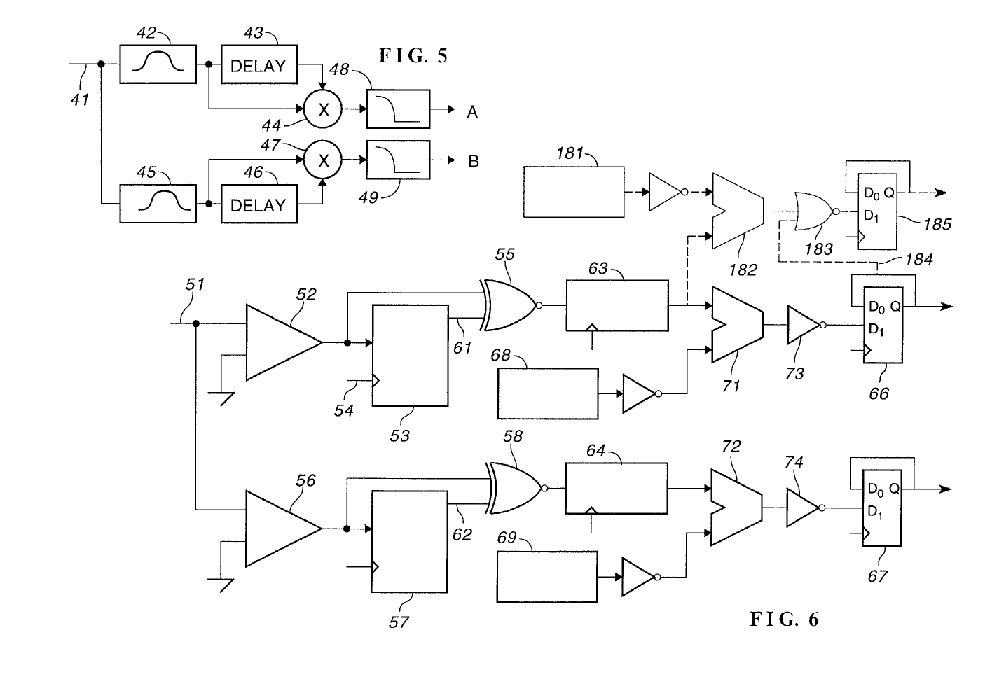

The circuit of FIG. 5 can be implemented analog or digital form but digital is preferred. FIG. 6 is a digital implementation of FIG. 5 and is a preferred embodiment of the invention. FIG. 6 has the advantage of being more compact in integrated circuit form than other embodiments of the invention. For example, shift registers are much smaller delay devices than switched capacitor circuits.

Multipliers 44 and 47 (FIG. 5) essentially correlate zero crossings. Thus, the signal on input 51 is digitized by applying the signal to a first input of comparator 52 having analog ground as the reference signal coupled to a second input. The output of comparator 52 is coupled to shift register 53 and to one input of exclusive-NOR circuit 55. Tap 61 from shift register 53 is coupled to a second input of exclusive-NOR circuit 55. Similarly, input 51 is coupled to one input of comparator 56, the output of which is coupled to shift register 57 and exclusive-NOR circuit 58. Tap 62 from shift register 57 is coupled to a second input of exclusive-NOR circuit 58. The taps correspond to the delays imposed in creating the shadows. A clock signal on input 54, and on similar inputs of other devices in FIG. 6, synchronizes operation.

The output of exclusive-NOR circuit 55 is coupled to accumulator (counter) 63. The output of exclusive-NOR circuit 58 is coupled to accumulator (counter) 64. The combination of an exclusive-NOR circuit and a counter acts as a multiplier and an integrator to indicate a shadow component in the incoming signal. Each multiplication causes an output pulse to be produced and counted. A reset signal (not shown) is sent periodically to accumulators 63, 64, and to D-flip-flops 66 and 67. It is assumed that a predetermined number of pulses within a reset period, e.g. 250 pulses within 50 milliseconds, indicates a correlation between the two input signals. Other quantities could be chosen.

Registers 68 and 69 are each loaded with a predetermined count, which need not be the same for each shadow. The outputs of the registers are inverted and applied to adders 71 and 72. The counts in registers 68 and 69 are subtracted from the counts in accumulators 63 and 64. At positive difference between the values in counters 63 and register 68, a negative output is produced by adder 71, the output is inverted by inverter 73 and is coupled to D-flip-flop 66. An output from D-flip-flop 66 indicates the presence of an “A” shadow. Similarly, at positive difference between the values in counter 64 and register 69, a negative output is produced by adder 72, the output is inverted by inverter 74 and coupled to D-flip-flop 67. An output from D-flip-flop 67 indicates the presence of a “B” shadow. The Q outputs of the D-flip-flops are fed back to the D₀ inputs to latch the output once the predetermined count is reached. The outputs remain latched until the next clear signal.

Accumulators 63 and 64 assure a reliable indication of the presence of a shadow and periodically resetting the counters assures that the system can adapt quickly to changes in environment. Although two shadows are detectable by the apparatus of FIG. 6, the apparatus can be replicated to detect any number of shadows, provided that the shadows are sufficiently separated.

The information contained in a shadow can be data or control instructions, e.g. to reduce the gain of an amplifier. Another control function is the selection of one of two groups of complementary comb filters in a telephone by detecting an “A” or a “B” delay and enabling the corresponding set of filters.

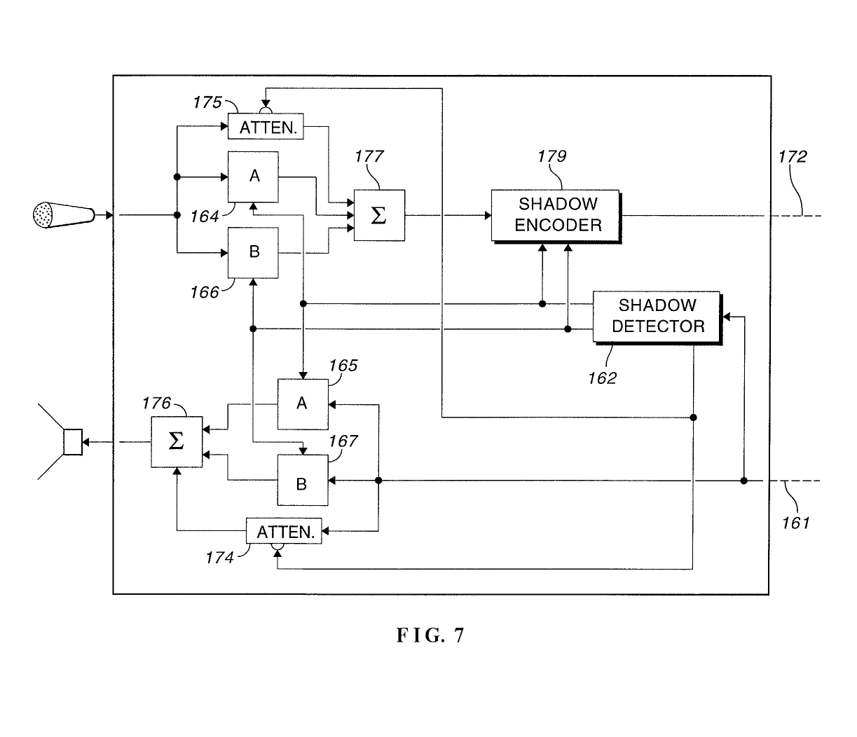

FIG. 7 is a block diagram of a shadow detection system for a telephone. Line input 161 is monitored by shadow detector 162. If the A filters should be used, then an enable signal is sent to filters 164 and 165. If the B filters should be used, then an enable signal is sent to filters 166 and 167. If either set of filters is enabled, then a signal is sent to attenuators 174 and 175, enabling the attenuators and preventing signals on line input 161 from reaching summation circuit 176 or a signal from the microphone to reach summation circuit 177. If neither set of filters is enabled, i.e. the telephone is in a half duplex mode, then the control signals are reversed. Specifically, filters 164, 165, 166, and 167 are disabled and attenuators 174 and 175 are opened (filters are bypassed).

A summation circuit provides a convenient means for combining the signals from the filter sets and the attenuator. A switch controlled by shadow detector 162 could be used instead, on the inputs or on the outputs to the filter sets, or both, but this is a more complicated circuit, even though attenuators 174 and 175 could be eliminated by the switches.

Shadow encoder 179 operates as described in connection with FIG. 1 or FIG. 3; i.e. a signal is divided into a plurality of bands prior to generating one or more shadows in one or more bands. Control signals from shadow detector 162 select the appropriate delay.

As described thus far, the amplitude of a shadow is the same, or nearly the same, as the amplitude of the original signal. This is not a requirement of the invention. On the contrary, instead of using more than one delay and creating several shadows, one can use more than one amplitude to create several shadows.

In FIG. 6, the value in accumulator 63 is linearly proportional to amplitude. Adding second register 181 and second adder 182 enables one to check the incoming signal for two shadows of different amplitude but the same delay. For example, if the count in register 181 is half the count in register 68, then adder 182 will reach zero sooner than adder 61. When the output from adder 182 goes low, flip-flop 185 is set, producing a signal indicating a “little A” shadow. When the output of adder 61 goes low, flip-flop 66 is set, producing an output signal indicating that a “big A” shadow was detected. The output from flip-flop 66 is coupled to an input to NOR gate 183 to prevent both outputs from being high at the same time.

The invention thus provides an apparatus and method for communicating data, including control signals, unobtrusively within the voice band over a telephone line during a conversation. The transmissions are simultaneous with voice signals, i.e. without multiplexing voice and data. Among many possible uses for the invention, one can control complementary comb filters or the gain of an amplifier in a telephone during a telephone conversation. Data can be encoded as amplitude variations in the shadow, delay variations in the shadow or both. Separate data streams can be sent simultaneously by encoding one as variations in amplitude and encoding another as variations in delay. The number of shadows is greatly increased and false correlation is prevented.

Having thus described the invention, it will be apparent to those of skill in the art that many modifications can be made with the scope of the invention. For example, although described in terms of a telephone system, the invention can be used anywhere one wants to send data with an audio signal. The shadow can be removed or left, as desired, in the signal sent to the speaker in the telephone.

What is claimed as the invention is:

1. A method for transferring data over a telephone line during a conversation, said method comprising the steps of:
dividing an audio signal into a plurality of bands;
delaying the portion of the audio signal in at least one band by less than fifty milliseconds to produce a shadow signal; and
combining the shadow signal with the portion of the audio signal; and
combining the portions to produce a reconstructed audio signal;
wherein the delay represents the data to be transferred.

2. The method as set forth in claim 1 wherein the presence or absence of a shadow signal represents data.

3. The method as set forth in claim 1 wherein at least two shadow signals are produced and the data is represented by two of the shadow signals.

4. The method as set forth in claim 3 wherein the shadow signals occur in different bands.

5. The method as set forth in claim 4 wherein the amount of delay of a portion in a band does not equal the period of a frequency within that band.

6. Apparatus for modulating an audio signal with data, said apparatus comprising:
a plurality of band pass filters having a common input and an output;
a plurality of delay lines, each having an input coupled to the output of a band pass filter and an output;
a plurality of summation circuits each having a first input coupled to the input of a delay line and a second input coupled to an output of the same delay line;
wherein the maximum delay is less than fifty milliseconds.

7. The apparatus as set forth in claim 6 wherein the delay line coupled to a band pass filter does not delay a signal by an amount equal to the period of a the center frequency of the pass band.

8. The apparatus as set forth in claim 6 wherein the delay line coupled to a band pass filter does not delay a signal by an amount equal to the period of a frequency within the pass band.

9. In a telephone having a line output and a line input and capable of operating in half duplex mode, the improvement comprising:
said telephone having at least two, separate machine states;
a detector for detecting a shadow signal on said line input; and
means coupled to said detector for selecting a machine state in accordance with a shadow signal on said line input.

10. The telephone as set forth in claim 9, wherein said detector comprises:
a band pass filter;
a delay line having an input coupled to said band pass filter and at least one output;
a correlator having a first input coupled to the input of said delay line, a second input coupled to an output of said delay line, and an output; and
a low pass filter coupled to the output of said correlator;
wherein the maximum delay of said delay line is less than fifty milliseconds.

11. The telephone as set forth in claim 10 wherein the period of delay by said delay line does not equal the period of the center frequency of said band pass filter.

12. The telephone as set forth in claim 10 wherein the period of delay by said delay line does not equal the period of a frequency within the pass band.

13. Apparatus for detecting the presence of a shadow in an audio signal, said apparatus comprising:
a band pass filter;
a delay line having an input coupled to said band pass filter and at least one output;
a correlator having a first input coupled to the input of said delay line, a second input coupled to an output of said delay line, and an output; and
a low pass filter coupled to the output of said correlator;
wherein the maximum delay of said delay line is less than fifty milliseconds.

14. The apparatus as set forth in claim 13 wherein the period of delay by said delay line does not equal the period of the center frequency of said band pass filter.

15. The apparatus as set forth in claim 13 wherein the period of delay by said delay line does not equal the period of a frequency within the pass band.

16. A method for transferring data within the voice band over a telephone line during a conversation, said method comprising the steps of:
delaying an audio signal less than 50 milliseconds to produce a shadow signal; and
combining the shadow signal with the audio signal.
